(19) United States
(12) Patent Application Publication
(10) Pub. No.: US 2026/0093636 A1
(43) Pub. Date: Apr. 2, 2026

(54) READ MODIFY WRITE OPTIMIZATION USING NEW BITFIELD COMPARE AND UPDATE INSTRUCTIONS

(71) Applicant: ADVANCED MICRO DEVICES, INC., Santa Clara, CA (US)

(72) Inventors: Neeraj Upadhyay, Bangalore (IN); Ranjal Gautham Shenoy, Bangalore (IN)

(21) Appl. No.: 18/899,088

(22) Filed: Sep. 27, 2024

(51) Int. Cl. G06F 12/12

(52) U.S. Cl. CPC G06F 12/12

(57) ABSTRACT

A bitfield compare-and-update instruction separates compare and exchange operations on the same lock state variable. When executing the bitfield compare and update instruction, the processing system compares a portion of the lock state variable to a previously-loaded value and, in response to a match, updates a different portion of the lock state variable.

### BACKGROUND

To improve processing efficiency, processing systems often employ processing devices (e.g., CPU, GPU, etc.), having one or more processing cores in the one or more processing devices. The one or more processing devices and/or the one or more processing cores often operate using shared data (that is, data that is to be used by processes (e.g. threads) executing at different processors or processor cores. The processing system manages access to the shared data, so that the shared data is not being altered (e.g., written) by one process at the same time that the data is being read by a different process.

In order to manage access to the shared data, the one or more processing devices employ a lock state variable. Before the shared data can be accessed by a processing device, the processing device is required to acquire the lock state variable, and then is required to release the lock state variable when the processing device finishes accessing the shared data. To acquire or release the lock state variable, the one or more processing devices employ an instruction set architecture (ISA) that defines compare and exchange operations. That is, the ISA includes an instruction that atomically exchanges the value of the lock state variable with a new value, if the current value at the address has not changed from a prior read/load of the lock state variable. In the conventional compare and exchange, the values of the lock state variable are checked during the compare and exchange operation, and only if the variable is found unchanged does the exchange operation get performed. However, conventional approaches to compare and exchange operations can result in a high incidence of unbounded (i.e., unrestricted, without limit) reading of data by one or more processing devices and starvation (i.e., lack of task execution) by other processing devices waiting for the shared resource. Also, the high incidence of unbounded reading of data and starvation occurs even in scenarios when there are no writers (i.e., processors that perform a write operation), but just concurrent readers (i.e., processors that perform a read operation) wanting to register their presence. Although starvation of the one or more processing devices and/or the one or more processing cores can be prevented by propagating older states of the lock state variable, other processing devices seeking to read data (i.e., readers) do not benefit because the entire lock state variable is checked. For example, if two or more processing cores attempt to access the shared resource while one processing core is accessing (e.g., reading, writing) the shared resource, the lock state variable is locked. Once the first processing core updates the lock state variable, such that the compare and exchange operation successfully completes, one or more other processing cores that were waiting could wait indefinitely because the other processing cores attempting access to the lock state variable will fail compare and exchange operations due to comparing older states with a potentially updated state (e.g., after the first processing core has updated the lock state after the other processing cores read the old state).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some embodiments.

FIG. 2 is a block diagram of a lock state variable in a cache line in accordance with some embodiments.

FIG. 3 is a diagram illustrating an example of a first set of operations to lock a semaphore at a processing system in accordance with some embodiments.

FIG. 4 is a diagram illustrating an example of a second set of operations to lock a semaphore at a processing system in accordance with some embodiments.

FIG. 5 is a flow diagram illustrating a method for obtaining a lock for shared data at a processing system in accordance with some embodiments.

### DETAILED DESCRIPTION

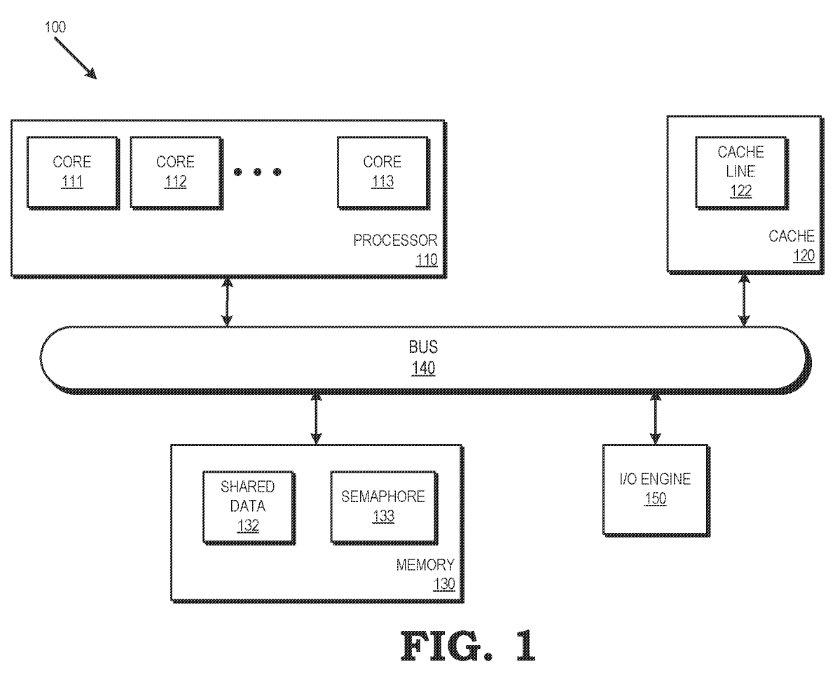

FIGS. 1-5 illustrate techniques for an atomic instruction, referred to as a bitfield compare-and-update instruction, that separates compare and exchange operations on the same lock state variable. When executing the bitfield compare and update instruction, the processing system compares a portion of the lock state variable to a previously-loaded value and, in response to a match, updates a different portion of the lock state variable. This reduces contention among read-only threads (that is, program threads that are only attempting to read shared data associated with the lock state variable). In addition, the bitfield compare-and-update instruction ensures that cache snoop propagation delays do not result in relatively high lock acquire times and reduces the likelihood of starvation for read only threads, thereby improving processing efficiency.

To illustrate, in order to control access to shared data, a processing system employs a lock state variable (sometimes referred to as a semaphore) having, for example, a word size of 8 bytes or 64 bits. To facilitate atomic manipulation of the lock state variable through acquire or release of a lock state, an instruction set architecture (ISA) employs read-modify-write (RmW) primitives (i.e., a fundamental data type or code that is a building block for instructing a processor to perform more complex operations). The conventional compare and exchange operation is one such instruction. When executed the compare and exchange operation compares the value of the semaphore to a previously-read value, and exchanges the semaphore value with a new value, if the comparison indicates the semaphore value has not yet changed. If the compare and exchange operation completes successfully, the processing device that issued the instruction has acquired a lock on the semaphore and is thus able to access the shared data corresponding to the semaphore. However, the conventional compare and exchange operation can result in starvation for read-only threads.

For example, when N different threads each concurrently execute a compare and exchange operation on the semaphore (that is, the three different threads concurrently attempt to obtain a lock on the semaphore), the compare and exchange operation will fail for N-1 of the threads, and each of the N-1 threads must repeat the compare and exchange operation multiple times until the lock is obtained. For processing systems executing a large number of threads, a thread can become “starved” when the thread must wait a relatively long amount of time to obtain a lock on the semaphore. Furthermore, in at least some cases the N threads are “read-only” threads, in that they are only seeking to read the shared data associated with the semaphore and are not seeking to write or otherwise modify the shared data. In these cases, the conventional compare and exchange operation causes a delay in the threads accessing the shared data without providing a protective benefit. That is, because the threads are not seeking to modify the shared data, providing concurrent access to the shared data is not likely to result in system errors, but the conventional compare and exchange operation does not allow for such concurrent access.

In contrast, using the techniques described herein, a bitfield compare-and-update operation is executed that compares only a first portion of the present state of the semaphore to the local state, wherein the first portion indicates a number of threads that are going to write to the shared data (referred to as writers) or that are waiting to read or write to the thread (referred to as waiters) . In response to the comparison showing no changes to values, the one or more processing devices update values in a second portion of the semaphore. As such, since only the portion of the semaphore corresponding to writers and waiters is checked, a set of read-only threads are able to obtain a lock on the semaphore more quickly, thereby improving overall processing efficiency. Further, the one or more processing devices are not restricted from ever registering their presence in the lock state due to unbounded retries.

FIG. 1 illustrates a block diagram of a processing system 100 in accordance with some embodiments. The processing system 100 is generally configured to execute sets of instructions (e.g., computer programs) in order to carry out operations, as specified by the sets of instructions, on behalf of an electronic device. Accordingly, in different embodiments, the processing system 100 is part of any one of electronic devices, such as a desktop computer, a laptop computer, a server, a smartphone, a tablet, a game console, and the like.

In various embodiments, the processing system 100 includes a central processing unit (CPU) 110. The CPU 110 includes a plurality of processor cores 111, 112, 113 (collectively referred to herein as “the processor cores 111-113”) that execute instructions concurrently or in parallel. The number of processor cores 111-113 implemented in the CPU 110 is a matter of design choice and some embodiments include more or fewer processor cores than illustrated in FIG. 1. The processor cores 111-113 execute instructions stored in a memory device 130 (e.g., random-access memory (RAM), solid state drive (SSD), hard disk drive (HDD), flash memory, and the like) and the CPU 110 stores information in the memory device 130 including the results of the executed instructions. In different embodiments, the processing system 100 includes multiple CPUs 110 with each CPU 110 having the plurality of processor cores 111-113.

The processing system 100 further includes a cache 120. In some embodiments, the cache 120 is a hardware cache. In the depicted example, the cache 120 is illustrated to be a separate component from the cores 111-113. However, in different embodiments, each of the cores 111-113 have a cache 120 connected within each core. The cache 120 is a small, fast memory device, implemented as static random-access memory (SRAM) located relatively closer to the CPU 110 than the memory device 130. Moreover, the cache 120 is used to reduce access time by the CPU 110 to the memory device 130. Specifically, the cache 120 stores frequently accessed data from the memory device 130.

The processing system 100 also includes a bus 140 to support communication between entities implemented in the processing system 100. For example, the bus 140 facilitates communication between the CPU 110 and the cache 120 and/or the memory device 130. In other embodiments, the processing system 100 includes other buses, bridges, switches, routers, and the like, which are not shown in FIG. 1 for clarity.

An input/output (I/O) engine 150 handles input or output operations associated with I/O devices that are not shown in FIG. 1 for clarity, such as a display, keyboards, mice, printers, external disks, and the like. The I/O engine 150 is connected to the bus 140 to facilitate communication between the I/O engine 150 and the CPU 110, the cache 120, and the memory device 130.

The memory 130 stores shared data 132, representing data that is accessible by different threads executing at the cores 111-113. The memory 130 also stores a semaphore 133, representing a lock state variable corresponding to the shared data 132. That is, the processing system 100 is implemented so that, in order to obtain access to the shared data 132, a thread is expected to acquire a lock on the semaphore 133 as described further herein. In some embodiments, the semaphore 133 has a word size of 8 bytes or 64 bits.

To acquire a lock on the semaphore 133 for reading the shared data 132, a thread executing at one of the cores 111-113 executes a bitfield compare and update instruction. When executed, the bitfield compare and update instruction loads the value of the semaphore 133 from the memory 130 to a local register. This copy of the semaphore 133 is referred to as the local copy. The bitfield compare and update instruction then loads the semaphore 133 to the cache line 122 of the cache 120 and cache coherency circuitry (not shown) sets the cache line 122 to an exclusive state (so that the cache line 120 cannot be modified by other cores). The bitfield compare and update instruction then compares a portion of the local copy of the semaphore 133 to a corresponding portion of the semaphore 133 stored at the cache line 122. In response to a mismatch, the bitfield compare and update instruction returns a failure, indicating that a lock on the semaphore 133 has not been obtained (and thus the thread is not permitted to access the shared data 132). In response to a match, the bitfield compare and update instruction updates a different portion of the semaphore 133 at the cache line 122, such as by incrementing the different portion.

Because the bitfield compare and exchange operation compares only a portion of the different copies of the semaphore 133, the operation supports more rapid locking of the semaphore 133 by read-only threads. To illustrate, in some embodiments the semaphore 133 includes two portions: a portion indicating a number of readers (referred to as the “readers field”) for the shared data 132 and a portion indicating of the presence of writers and waiters (referred to as the “writer and waiter field”) for the shared data 132. A read-only thread (that is, a thread seeking only to read the shared data 132) uses the bitfield compare and exchange operation to only compare the writer and waiter field of the semaphore 133. Thus, if the presence of writers and waiters of the shared data 132 (that is, the number of threads seeking to write data to the shared data 132) does not change during execution of the bitfield compare and exchange instruction, the read-only thread is able to obtain a lock on the semaphore 133, and thus access the shared data 132. Accordingly, for a relatively high number of concurrent read-only threads, the processing system 100 reduces the amount of time it takes for all of the read-only threads to access the shared data 132, thus improving overall processing efficiency.

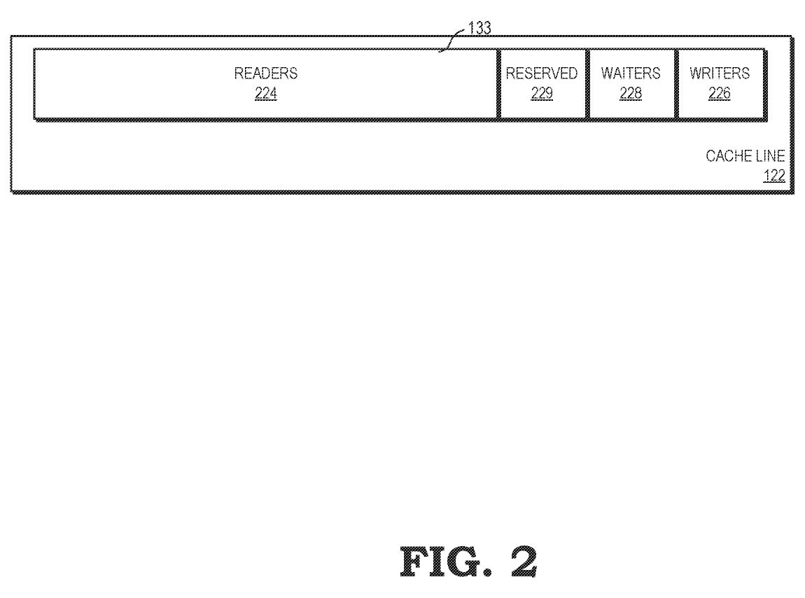

FIG. 2 illustrates a block diagram of the semaphore 133 as stored at cache line 222 in accordance with some embodiments. The semaphore 133, is used by the processor cores 111-113 to obtain access to shared data 132 or a shared resource (e.g., one or more addresses in the memory device 130, or one or more memory devices 130). For ease of description, the term shared data 132 as used herein can refer to either the shared data 132 or another shared resource. Additionally, in different embodiments, the semaphore 133 is used by one or more CPUs 110.

The semaphore will be described herein in an example implementation using the processor cores 111-113. However, in different embodiments, the semaphore 133 is accessible by one or more CPUs 110, GPUs, and any other processing device of the processing system 100. In the depicted example of FIG. 2, the semaphore 133 includes a plurality of bitfields. Specifically, in some embodiments, the semaphore 133 includes a readers bitfield 224, a writers bitfield 226, a waiters bitfield 228, and a plurality of reserved bitfields 230. The readers bitfield 224 is used as a counter to indicate a number of the processor cores 111-113 that have a pending read operation for the shared data 132. For ease of description, the processor cores 111-113 performing a read operation are referred to as readers. The writers bitfield 226 is used as an identifier to indicate that one of the processor cores 111-113 is performing a write operation on the shared data 132. In some embodiments, the writers bitfield 226 is a single bit that indicates whether one of the processor cores 111-113 has successfully registered to perform a write operation on shared data 132. For ease of description, the processor cores 111-113 performing a write operation are referred to as writers. The waiters bitfield 228 is used as an identifier (e.g., a single bit) that indicates that at least one of the processor cores 111-113 is currently waiting to perform a read operation or a write operation on the shared data 132. For ease of description, the processor cores 111-113 waiting to perform a read operation or a write operation are referred to as waiters. It will be appreciated that in the case of a read operation, the waiters bitfield 228 will identify a waiter following a writer that has been queued because there are active readers (as indicated by a non-zero read count, as described further herein).

The processor cores 111-113 employ an instruction set architecture (ISA) to atomically manipulate the semaphore 133. The ISA is a computing model used by the processing system 100 to execute instructions defined by the ISA. In other words, the ISA specifies the behavior of the processing system 100 when executing software. Moreover, the ISA employs read-modify-write primitives to manipulate the semaphore 133 through acquire or release of the semaphore 133. Specifically, the ISA includes an bitfield compare and update instruction that, when executed compares a value of a first portion of the semaphore 133 with a local value (e.g., a local count for each processor core based on a state of the semaphore 133 prior to receiving access to the semaphore 133, such that each processor core has a different stored value than another processor core, although in some cases, multiple processor cores have the same local value or local lock state, which was previously loaded) stored by the processor cores 111-113. Subsequently, based on the comparison of the value at the address with the stored value, the processor cores 111-113 update values in a second portion of the semaphore 133.

To illustrate via an example, a thread executing at the processor core 111 attempts to perform a read operation of the shared data 132 (e.g., an application file) and the processor core 112 attempts to perform a write operation for the shared data 132. Accordingly, the processor cores 111 and 112 each obtain a lock on the semaphore 133 by first loading a copy of the semaphore 133 from the memory 130 to a register of the corresponding processor. The processor core 111 then executes the bitfield compare and update instruction for the semaphore 133, and the processor core 112 executes a compare and exchange operation for the semaphore 133.

To execute the bitfield compare and update instruction, the processor core 111 loads the semaphore 133 to the cache line 122. The processor core 111 then compares the values of the waiters 228 and the writers 226 at the cache line 122 to the corresponding portions of the local copy of the semaphore 133. In response to a mismatch, the bitfield compare and update instruction returns a failure, and the processor core therefore fails to obtain a lock for the semaphore 133. In response to a match, the processor core 111 increments the value of the readers 224 at the cache line 122. It will be appreciated that the values stored at the writers bitfield 226, the waiters bitfield 228, and the plurality of reserved bitfields 229 will not change unless a write operation occurs, as will be described herein. That is, in cases where a processor core performs a write operation, the writers bitfield 226 will be set and a reader will never increment the value in the plurality of readers bitfields 224 because the writers bitfield 226 being set indicates a write operation on the shared data 132 is in progress. Conversely, incrementing the plurality of readers bitfields 224 indicates a read operation on the shared data 132 is in progress.

During the processor core 111 read operation on the shared data 132, the processor core 112 attempts to access the shared data 132 and the semaphore 133, but the semaphore 133 is already read-locked. Additionally, the processor core 112 is waiting to access the semaphore 133 and the shared data 132. The processor core 112 updates (e.g., increments by at least one) the waiters bitfield 228 (e.g., bit 1) to indicate that the processor core 112 is waiting to perform a write operation to the shared data 132 (e.g., write to the application file) once the processor core 112 obtains access to the semaphore 133. When a writer acquires the lock, the writer bit is set. Furthermore, the processor core 112 is added to a queue that is stored at, for example, the cache 120 and/or the memory device 130. After the processor core 111 completes the read operation, the lock state on the semaphore 133 is released and the global state is updated that reflects the read operation is completed (e.g., decrement the plurality of readers bitfields 224 by 1). Accordingly, the processor core 112 obtains the lock state on the semaphore 133. Since the processor core 112 is at the head of the queue and the waiters bitfield 228 is set (e.g., set the value to 1), it updates the writers bitfield 226 (e.g., set the value to 1) in the lock word and performs a write operation, it does not need to compare and performs the write operation on the shared data 132. Moreover, as discussed above, instead the processor core 112 updated the writers bitfield 226 and the waiters bitfield 228. It will be appreciated that based on the queue and the waiters bitfield 228, additional processing devices, such as the processor core 111, the processor core 113, and any additional processing device are restricted to performance of a read operation or a write operation in bounded time. In other words, the lock state is held by the processing device for a relatively small period of time. Moreover, each processing device receives access to the semaphore 133 in sequential order based on the queue, if applicable (e.g., there is no queue if no waiters), for a substantial (e.g., more than 99%) portion of the time and is not starved based on retry loops (e.g., at least one processing device obtaining access to the semaphore 133 before a processing device that attempted access prior).

Lastly, the processor core 113 attempts to access the shared data 132 and the semaphore 133, but semaphore 133 is already write-locked by the processor core 112. Additionally, the processor core 113 is waiting to access the semaphore 133 and the shared data 132. The processor core 113 updates the waiters bitfield 228 (e.g., bit 1) to indicate that the processor core 113 is waiting to perform the read operation. Furthermore, the processor core 113 is added to a queue that is stored at, for example, the cache 120 and/or the memory device 130. After the processor core 112 completes the write operation, the write-lock state on the semaphore 133 is released and the global state is updated that reflects completion of the write operation and adjusts the value in the writers bitfield 226 (e.g., reset the value to 0) and the waiters bitfield 228 unless there are more waiters in the queue. Accordingly, the processor core 113 obtains the lock state and compares values in the first portion of the semaphore 133 based on the global state of the semaphore 133 to a third stored value (e.g., local state of the processor core 113). Specifically, the processor core 113 compares the first eight bits of the semaphore 133 including the writers bitfield 226, the waiters bitfield 228, and the plurality of reserved bitfields 229 to the third stored value, which corresponds to the first eight bits of the semaphore 133. Based on the comparison of the values stored at the writers bitfield 226, the waiters bitfield 228, and the plurality of reserved bitfields 229 matching the third stored value, the processor core 113 performs the read operation on the shared data 132. While the processor core 113 performs the read operation on the shared data 132, it also updates (e.g., increments the value of) at least one of the plurality of readers bitfields 224 in the remaining fifty-six bits (e.g., 8 to 63) of the semaphore 133. After the processor core 113 completes the read operation, the lock state on the semaphore 133 is released and the global state is updated that reflects the read operation is completed and adjusts the value in the plurality of readers bitfields 224 (e.g., decrements the value of).

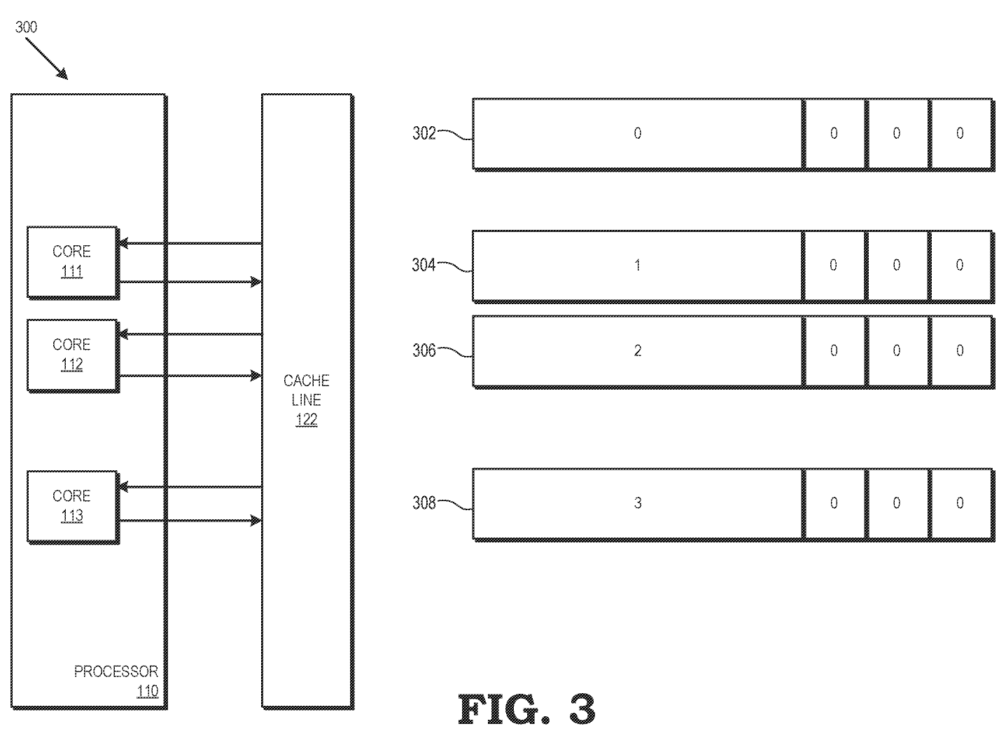

FIG. 3 illustrates a diagram of an example of state changes 300 based on a bitfield compare and update operation on the semaphore 133 in accordance with some embodiments. The example of state changes 300 is implemented by aspects of the processing system 100 as described with reference to FIGS. 1 and 2. At state 302, the global state for the semaphore 133 is unchanged. In particular, all of the values in the semaphore 133 are zero. At state 304, the processor core 111 attempts to perform a read operation of the shared data 132 at the cache line 122. The processor core 111 compares the values of a first portion of the semaphore 133 at the cache line 122to the previously loaded local copy of the first portion of the semaphore 133. Specifically, the processor core 111 compares the writers bitfield 226, the waiters bitfield 228, and the plurality of reserved bitfields 229 to the local copy. The values of the writers bitfield 226, the waiters bitfield 228, and the plurality of reserved bitfields 229 are zero, which matches the local copy. Based on the comparison of the values stored at the writers bitfield 226, the waiters bitfield 228, and the plurality of reserved bitfields 229 matching the local copy, the processor core 111 first updates the second portion i.e., the readers count bitfield 224, by incrementing the value by 1, there by registering the presence of this reader. The processor core 111 then performs the read operation on the shared data 132. While the processor core 111 performs the read operation on the shared data 132, it also increments the plurality of readers bitfields 224 of the semaphore 133 by one. As such, the plurality of readers bitfields 224 indicates one read operation is being performed. Once the processor core 111 completes the read operation, it will decrement the value in the plurality of readers bitfields 224 of the semaphore 133 by 1, to indicate one fewer reader for the shared data.

At state 306, the processor core 112 attempts to perform a read operation of the shared data 132, and therefore initiates a bitfield compare and update operation. Unlike in conventional methods of compare and exchange that compare values in the entire semaphore 133, using the techniques herein, the processor core 112 executes the bitfield compare and update operation by comparing values in the first portion of the semaphore 133 based on a latest global state (e.g., after the update by the processor core 111) of the semaphore 133 to the local copy previously loaded from memory. However, since the processor core 111 did a read operation, the writers bitfield 226 were not changed. Thus, the processor core 112 compares the writers bitfield 226, the waiters bitfield 228, and the plurality of reserved bitfields 229 to the local copy. The values of the writers bitfield 226, the waiters bitfield 228, and the plurality of reserved bitfields 229 are zero, which matches the local copy. Based on the comparison of the values stored at the writers bitfield 226, the waiters bitfield 228, and the plurality of reserved bitfields 229 matching the second stored value, the processor core 112 updates the readers count bitfield 224, by incrementing the value by 1, thereby registering the presence of the reader. The processor core 112 then performs the read operation on the shared data 132. While the processor core 112 performs the read operation on the shared data 132, it also increments the plurality of readers bitfields 224 of the semaphore 133 by 1. As such, the plurality of readers bitfields 224 indicates two read operations are being performed. The plurality of readers bitfields 224 indicates a count of a number of active readers performing the read operations. Once the processor core 112 completes the read operation, it will decrement the value in the plurality of readers bitfields 224 of the semaphore 133 by one.

At state 308, the processor core 113 attempts to perform a read operation of the shared data 132, and therefore initiates a bitfield compare and update operation for the semaphore 133. As in the case of the processor core 111 and the processor core 112, the processor core 113 compares values in the first portion of the semaphore 133 based on the latest global state (e.g., after the update by the processor core 112) of the semaphore 133 to the local copy. However, since the processor cores 112 and 113 each did a read operation, the first eight bits were not changed. Thus, the processor core 113 compares the writers bitfield 226, the waiters bitfield 228, and the plurality of reserved bitfields 229 to the local copy, which corresponds to the first eight bits of the semaphore 133. The values of the writers bitfield 226, the waiters bitfield 228, and the plurality of reserved bitfields 229 are zero, which matches the local copy. Based on the comparison of the values stored at the writers bitfield 226, the waiters bitfield 228, and the plurality of reserved bitfields 229 matching the third stored value, the processor core 113 updates the readers count bitfield 224, by incrementing the value by 1, thereby registering the presence of the reader. As such, the plurality of readers bitfields 224 indicates three read operations are being performed. The processor core 113 then performs the read operation. After the processor core 113 completes the read operation, the that the processor core 113 adjusts the readers count bitfield, reducing the value by 1 to reflect that the read operation is completed.

Thus, for the example of FIG. 3, the bitfield compare and update operation allows readers to perform read operations while there are no waiters or writers to the shared data 132. In contrast, in a conventional system employing a compare and exchange operation, the changing read count would result in a compare and exchange failure at one or more of the readers. This in turn would lead to one or more of the readers retrying the compare and exchange operation one or more times, with no bound on the number of retries.

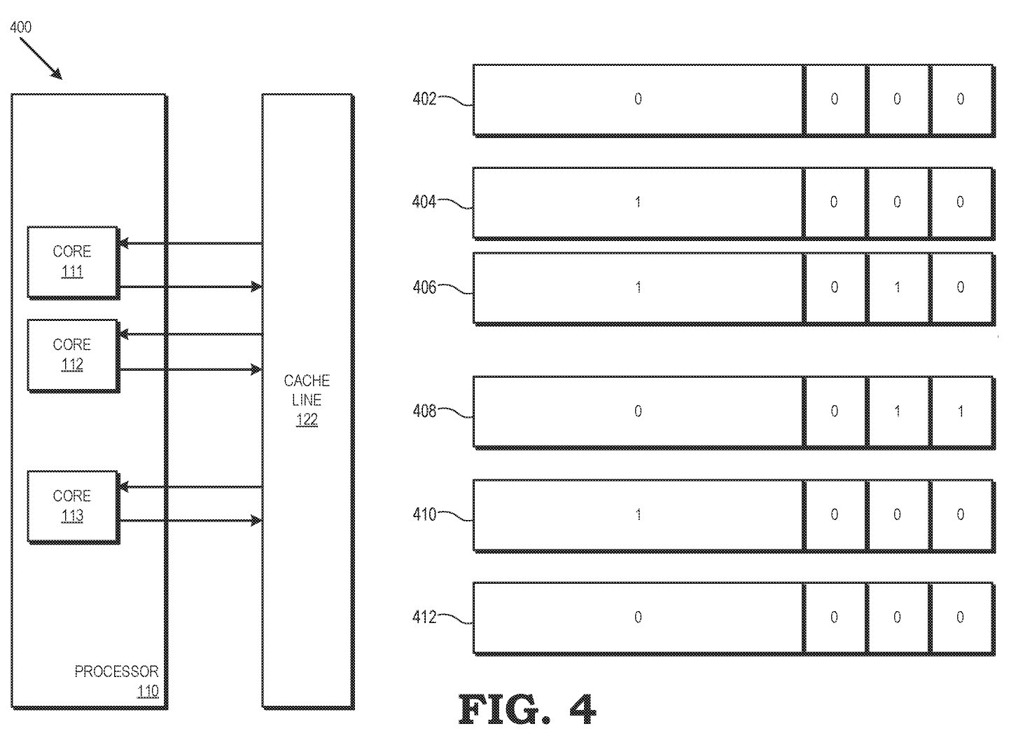

FIG. 4 illustrates a diagram of an example of state changes 400 based on a set of read operations or write operations on the semaphore 133 in the cache line 122 in accordance with some embodiments. The example of state changes 400 is implemented by aspects of the processing system 100 as described with reference to FIGS. 1 and 2. At state 402, the global state for the semaphore 133 is unchanged. In particular, all of the values in the semaphore 133 are zero. At state 404, the processor core 111 attempts to perform a read operation of the shared data 132. The processor core 111 loads the semaphore 133 to the cache line 122. The processor core 111 compares values in the first portion of the semaphore 133 to the previously loaded local copy of the semaphore 133. Specifically, the processor core 111 compares the writers bitfield 226, the waiters bitfield 228, and the plurality of reserved bitfields 229 to the local copy, which corresponds to the first eight bits of the semaphore 133. The values of the writers bitfield 226, the waiters bitfield 228, and the plurality of reserved bitfields 229 are zero, which matches the local copy. Based on the comparison of the values stored at the writers bitfield 226, the waiters bitfield 228, and the plurality of reserved bitfields 229 matching the local copy, the processor core 111 updates the readers count bitfield 224, by incrementing the value by 1, thereby registering the presence of the reader. As such, the plurality of readers bitfields 224 indicates one read operation is being performed. The processor core 111 the initiates the read operation for the shard data.

At state 406, the processor core 111 is still performing the read operation. It is assumed for state 406 that the processor core 112 has previously initiated an attempted to perform a write operation to write to the shared data 132 and therefore has previously loaded a local copy of the semaphore 133. At state 406, the processor core has initiated a compare and exchange operation for the entire semaphore 133 to attempt to secure a lock. This compare and exchange operation compares all of the bits of the semaphore 133 at the cache line 122 to the local copy and identifies a mismatch (resulting from the change in the readers 224 by the processor core 111. The compare and exchange operation therefore indicates that the semaphore 133 is already read-locked. Therefore, the processor core 112 updates the waiters bitfield 228 to indicate that the processor core 112 is waiting to perform the write operation. Furthermore, the write operation of the processor core 112 is added to a queue (not shown).

At state 408, the processor core 111 has completed performing the read operation, and has therefore decremented the readers count bitfield 224, which indicates that the number of readers is zero. Accordingly, the processing system 100 initiates execution of the operations stored at the queue. In particular, the processor core 112 initiates execution of the write operation stored at the queue by setting the writers bitfield 226 to a one, indicating a write operation is being performed. At state 408, the processor core 113 attempts a read access to the shared data 132 and therefore initiates a bitfield compare-and-update operation for the semaphore 133. The bitfield compare-and-update operation indicates that the value of the waiters field 228 and the writers field 226 does not match the local copy, thus indicating the presence of a writer and therefore that the semaphore 133 is already locked. The processor core 113 therefore does not execute the read operation at this time.

At state 410, the processor core 112 has completed the write operation, and has set the waiters bitfield 228 and the writers bitfield 226 to zero, indicating there are no waiters or writers for the shared data. The processor core 113 retries the bitfield compare and update operation. The operation indicates that the number of writers and waiters matches the local copy of the semaphore at the processor core 113, and thus that the number of writers and waiters is zero. Accordingly, the processor core 113 increments the readers count bitfield 224 (thus setting the number of readers to one). The processor core 113 executes the read operation, and then decrements the readers count bitfield 224, setting number of readers to zero as shown at state 412.

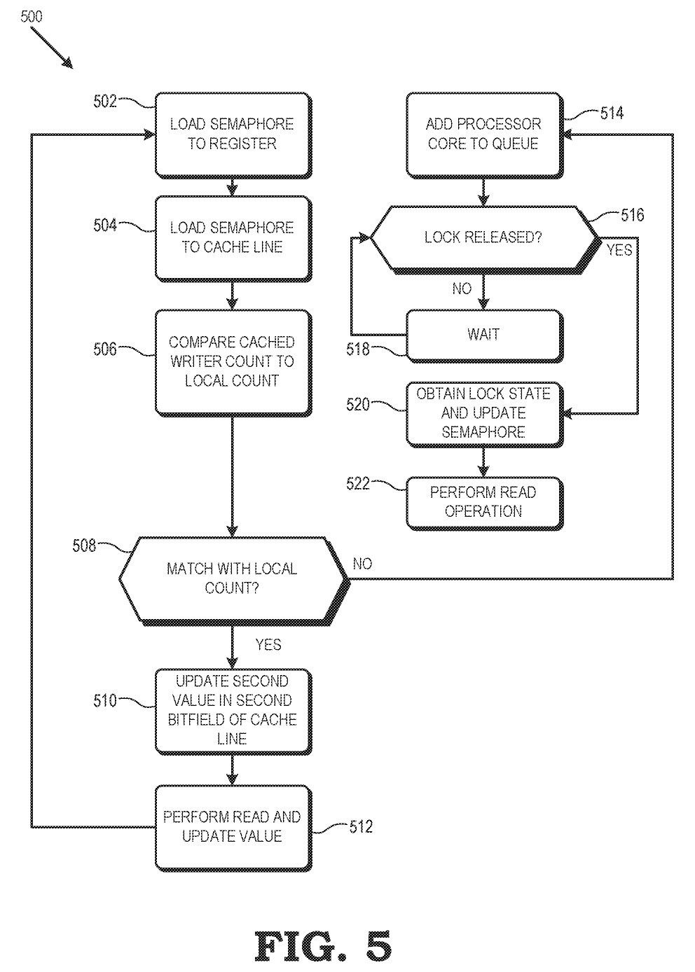

FIG. 5 is a flow diagram illustrating a method 500 for comparing a first bitfield in the cache line 120 to a local count and updating a second bitfield while the first bitfield matches the local count in accordance with some embodiments. The method 500 is described with respect to an example implementation of the processing system 100 of FIG. 1. At block 502, the processor cores 111-113 load the semaphore 133 from the memory 130 to a corresponding register of the processor core. The semaphores stored in these registers are referred to as the local copy of the semaphore for the corresponding register. At block 504, the processor core 111 initiates a bitfield compare and update operation by loading the semaphore 133 to the cache line 122 in an exclusive state. At block 506, the processor core 111 compares values in the first portion of the semaphore 133 at the cache line 122 to the corresponding portion of the local copy. Specifically, the processor core 111 compares the first eight bits of the semaphore 133 including the writers bitfield 226, the waiters bitfield 228, and the plurality of reserved bitfields 229 to the local copy. At block 508, the processor core 111 determines whether the compared values match. If so, the method proceeds to block 510, and the processor core 111 updates (e.g., increments) at least one of the plurality of readers bitfields 224 in the remaining fifty-six bits of the semaphore 133 to indicate an additional reader. At block 512, the processor core 111 executes the read operation and updates (e.g. decrements) the least one of the plurality of readers bitfields 224 in the remaining fifty-six bits of the semaphore 133 to indicate one less reader. The method flow returns to block 502.

Alternatively, if at block 508, the comparison of the bitfields at the cache 122 and the local copy have a mismatch, the method flow moves to block 514 and an identifier for the processor core 111 is added to a queue. At block 516, the processor determines whether the lock of the semaphore 133 has been released. If not, the method flow moves to block 518 and the processor waits until the lock on the semaphore 133 has been released. Once the lock is released, the method flow moves to block 520 and the next processor core in the queue obtains the lock for the semaphore 133 and updates the semaphore 133 to indicate the lock state. The method flow proceeds to block 522 and the processor core performs the read operation that was pending in the queue.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
determining, at a processor, that a first processor core is to access shared data; and
in response to the determining:
comparing a first portion of a first cache line to a first local copy at the first processor core; and
modifying a second portion of the first cache line in response to the comparing indicating a match.

2. The method of claim 1, wherein the first cache line stores a semaphore associated with the shared data.

3. The method of claim 1, wherein the first portion comprises data indicating whether a second processor core is waiting to write to the shared data.

4. The method of claim 1, further comprising:
executing a read operation for the shared data in response to the comparing indicating a match.

5. The method of claim 1, wherein updating the second portion comprises:
adjusting the second portion of the first cache line to indicate an additional reader of the shared data.

6. The method of claim 4, wherein the second portion of the first cache line indicates a number of processor cores that are concurrently reading the shared data.

7. The method of claim 1, further comprising:
determining, that a second processor core is to access shared data; and
in response to the determining:
comparing a first portion of a second cache line to a second local copy at the second processor core; and
modifying a second portion of the second cache line in response to the comparing indicating a match.

8. A processing system, comprising:
at least one processor comprising a first processor core, the processor configured to:
in response to determining that the first processor core is to access shared data:
compare a first portion of a first cache line to a first local copy at the first processor core; and
modify a second portion of the first cache line in response to the comparing indicating a match.

9. The processing system of claim 8, wherein the first cache line stores a semaphore associated with the shared data.

10. The processing system of claim 9, wherein the first portion comprises data indicating whether a second processor core is waiting to write to the shared.

11. The processing system of claim 8, wherein the first processor core is to execute a read operation for the shared data in response to the comparing indicating a match.

12. The processing system of claim 11, wherein the processor is to adjust the second portion of the first cache line to indicate an additional reader of the shared data.

13. The processing system of claim 11, wherein the second portion of the first cache line indicates a number of processor cores that are concurrently reading the shared data.

14. The processing system of claim 8, further comprising a second processor core, and wherein the processor is to:
in response to determining that the second processor core is to the access shared data:
compare a first portion of a second cache line to a second local copy at the second processor core; and
modify a second portion of the first cache line in response to the comparing indicating a match.

15. A method, comprising:
comparing, at a first processor core, a first portion of a semaphore to a local count that corresponds to the first portion semaphore; and
obtaining access to shared data based on the comparing.

16. The method of claim 15, wherein the first portion of the semaphore indicates whether a second processor core is to write to the shared data.

17. The method of claim 15, further comprising updating a second portion of the semaphore based on the comparing.

18. The method of claim 17, wherein the second portion indicates a number of processor cores that are to read the shared data.

19. The method of claim 15, wherein comparing comprises comparing the first portion of the semaphore stored at a cache associated with the processor core.

20. The method of claim 15, wherein obtaining access comprises obtaining access in response to the comparing indicating a match.
